(19) United States
(12) Patent Application Publication
(10) Pub. No.: US 2017/0355352 A1
(43) Pub. Date: Dec. 14, 2017

(54) Conformal Heater for Windshield Washer Nozzle

(71) Applicant: ILLINOIS TOOL WORKS INC., Glenview, IL (US)

(72) Inventors: Edward Bulgajewski, Genoa, IL (US); Martin Kluge, Rottingen (DE); Uwe Stapf, Rottingen (DE); Florian Duell, Rottingen (DE)

(21) Appl. No.: 15/531,119

(22) PCT Filed: Nov. 24, 2015
(86) PCT No.: PCT/US2015/062306

§ 371 Date: May 26, 2017

Related U.S. Application Data
(60) Provisional application No. 62/101,041, filed on Jan. 8, 2015.

(51) Int. Cl. B60S 1/52; H05B 3/42

(52) U.S. Cl. CPC B60S 1/52; H05B 3/42

(57) ABSTRACT

A nozzle assembly (18) for a windshield washer system or the like provides an elongate heater element (30) that can extend along a supply tube connected to the washer nozzle (20) to better transfer heat energy into the washer fluid and the nozzle for preventing nozzle clogging caused by low temperatures.

### CROSS REFERENCE TO RELATED APPLICATIONS

This application claims the benefit of U.S. provisional applications provisional 62/101,041 filed on Jan. 8, 2015 and hereby incorporated by reference.

### FIELD OF THE INVENTION

The present invention relates generally to vehicular window washing systems and, in particular, to a vehicle window washing systems providing a nozzle heater.

### BACKGROUND OF THE INVENTION

Window washing systems, for example, for use on the windshield, may work in conjunction with vehicle windshield wipers to spray a cleaning fluid on the windshield during activation of the wipers. During winter months, an anti-freeze material such as alcohol may be added to the washing fluid to keep it from freezing. During those times, even when alcohol has been added to the washing fluid, the washing fluid nozzles, positioned in the wind stream and exposed to environmental moisture, may freeze over becoming inoperative at times when they are needed.

It is known to place ceramic, positive temperature coefficient (PTC) heating elements in the nozzle assembly to provide for localized heating of the nozzles that can prevent icing. The disk-shape ceramic element is normally potted with a resin material to protect it from humidity and to fill the gap between the nozzle and the rigid PTC heater.

### SUMMARY OF THE INVENTION

The present invention provides a heating element that better distributes heat to the nozzle and connecting tubing thereby increasing the contact area and decreasing the intervening thermal resistance to provide more efficient nozzle heating. The heating element may be a flexible strip of PTC material or PTC-coated material with applied electrodes that can flex so that the strip may have improved contact the nozzle. Alternatively, the heating element may be a PCT material applied directly on the nozzle and connecting tubing. By reducing the distance between the liquid and the heater and the thermal mass of the heater/nozzle system, heat may be more quickly applied to the nozzle for rapid availability as soon as the vehicle is started and for reduced heat loss and power consumption while in use.

In one embodiment, the invention provides a vehicular washer nozzle assembly having a housing adapted to attach to a vehicle adjacent to a window and a standpipe extending along an axis within the housing to terminate at a nozzle to direct a stream of liquid from the nozzle toward the window when the housing is attached to the vehicle. An elongate electrical heater element extends along a length of the standpipe to heat the same.

It is thus a feature of at least one embodiment of the invention to provide for a distributed rather than localized heat source greatly improving heat conduction into critical nozzle areas. In particular the invention may direct more heat into the nozzle and tubing (and possibly included washer fluid) and less heat into the material of the housing through its distributed and conformal nature.

The elongate electrical heater may be in contact with the majority of the length of the standpipe within the housing.

It is thus a feature of at least one embodiment of the invention to minimize the total thermal resistance between the standpipe and the heater by maximizing an area of contact.

The elongate electrical heater may provide electrodes extending along substantially the entire length of the heater strip within the housing adapted to communicate with a source of electrical power in the vehicle and separated by a resistive heating material.

It is thus a feature of at least one embodiment of the invention to greatly increase the heater area thereby improving distribution of heat through extended electrode geometry.

The electrodes may each provide for a comb structure presenting interdigitated comb fingers.

It is thus a feature of at least one embodiment of the invention to provide a large uniform heating area by using a highly distributed electrode structure.

The resistive heating element may be a polymer.

It is thus a feature of at least one embodiment of the invention to provide a robust heater element resistant to vibration and moisture.

The resistive heating element may be a positive temperature coefficient heating element.

It is thus a feature of at least one embodiment of the invention to eliminate the need for separate thermal sensing inside the housing for temperature control during a wide range of ambient temperatures. It is a further feature of at least one embodiment of the invention to provide for rapid heating without concern for hot spots or heater damage that might otherwise attend to high currents. The positive temperature control material naturally evens out heat and prevents hot spots.

The standpipe may be curved and the elongate electrical heater may curve to follow the standpipe.

It is thus a feature of at least one embodiment of the invention to provide a system that may work with curved fluid conduits desirable for particular vehicular applications.

The resistive heating element may be flexible to be curved during manufacture to follow the standpipe.

It is thus a feature of at least one embodiment of the invention allow improved conformance of the heater to an irregular nozzle and standpipe and improved manufacturability that may result from being able to deform the heater element during assembly.

The flexible heater strip may be exposed outside the housing to expose the electrodes to connection.

It is thus a feature of at least one embodiment of the invention to eliminate the need for separate wiring to terminals or the like.

The vehicular washer nozzle assembly may include a potting material for holding the elongate heater element in proximity with the standpipe.

It is thus a feature of at least one embodiment of the invention to provide a manufacturing technique for holding and contacting the heater element to an arbitrary nozzle and standpipe.

The standpipe may join with a feeder tube in a T-connection and the elongate electrical heater may include side arms that conform to the feeder to extend in opposite directions from the standpipe.

It is thus a feature of at least one embodiment of the invention provide a heater that can be flexibly designed to follow fluid lines in two dimensions.

The side arms maybe flexible to be curved for insertion into the housing and then to extend along the feeder tube.

It is thus a feature of at least one embodiment of the invention to allow for a heater to follow a complex tubing geometry.

The housing may be constructed a polymer material and the potting material has a lower thermal resistance than the housing.

It is thus a feature of at least one embodiment of the invention to assist in transferring heat from the heater element to the standpipe and nozzle and/or feeder tube using a conductive space filler.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of an automobile windshield from outside of the automobile showing the location of typical windshield washer nozzles such as may become blocked with ice;

FIG. 2 is a front elevational view of a nozzle of the present invention using a conformal flexible PTC heater strip inserted into a housing holding the nozzle;

FIG. 3 a front elevational view of the PCT heater strip for installation into a nozzle housing;

FIG. 4 is a cross-section along lines 4-4 of FIG. 2 showing flexible conformance of the PCT heater strip with the nozzle; and

FIG. 5 is a perspective rear view of an alternative embodiment with the PTC material and electrodes printed directly on the nozzle structure.

The term “along an axis” refers to a general orientation and should not be understood to require that a component extending along the axis be straight but only that it have a substantial component of extension along the axis.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

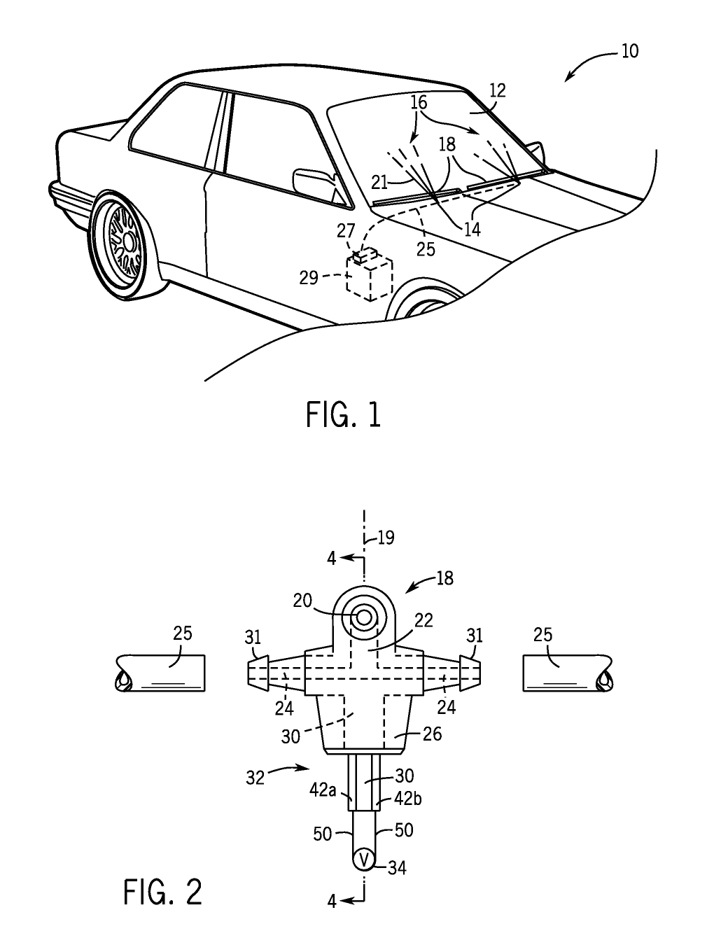

Referring now to FIG. 1, a vehicle 10 may provide for a window 12 such as a windshield positioned behind and above washer system nozzles 14 oriented to provide a spray 16 of washer fluid on the window 12 for cleaning with the wiper blades 18 as is generally understood in the art. Analogously, but not shown, the nozzles 14 may be positioned adjacent to other windows 12 including headlight lenses, cameras, and windows over radar, ultrasound or the like.

Referring now also to FIG. 2, each nozzle 14 may provide for nozzle 20 directing a stream of washer fluid 21 toward the adjacent window 12 and typically rear facing with respect to the direction of the forward vehicle. The nozzle 20 may communicate by standpipe 22 extending generally along an axis 19 with a feeder tube 24, the latter attached to flexible washer fluid hoses 25 leading from a washer pump 27 and fluid reservoir 29 and/or to a downstream nozzle 14. Although the standpipe 22 extends generally along an axis 19 it may curve as it connects to the nozzle 20 to direct the nozzle 20 in a desired direction. In one embodiment, the standpipe 22 may join in a T-connection to a center of the feeder tube 24 which extends horizontally and perpendicular to the upstanding standpipe 22 to terminate an opposed barb connection 31.

The standpipe 22 and feeder tube 24 may be premolded, for example, by injection molding, and contained within a housing 26 that serves to attach the nozzle 14 to the structure of the vehicle 10. As so contained, the nozzle 20 extends from an upper portion of the housing 26 and the feeder tube 24 extends outward from either side of the housing 26. The housing 26, the standpipe 22, and the feeder tube 24 will typically be molded of a thermoplastic material of low heat conduction.

A conforming heater strip 30 may provide for a connector end 32 extending from the housing 26 having electrodes 42a and 42b across which a heater voltage source 34 (such as 12 volts) may be applied during use. The electrodes 42a and 42b may extend along the length of the heater strip 30 on opposite sides of the heater strip and may include projecting comb fingers 43 such that comb fingers of the opposite electrodes 42a and 42b are interdigitated maximizing a current throughput in a uniform distributed fashion through a surrounding heating material.

Referring also to FIG. 4, the heater strip 30 may extend into the housing 26 and may closely underlie the nozzle 20 of the standpipe 22 and portions of the feeder tube 24 to be retained thereagainst by a structure of the housing 26 or an overmolding, molded structure of the housing 26, or potting compound 36. Ideally, the heater strip 30 is in contact with the standpipe 22 over the majority of its length. The potting compound 36 may provide for enhanced heat conduction when compared to the material of the housing 26, for example, by the inclusion of thermally conductive particles. The heater strip 30 may flex to follow a curved path of the standpipe 22 and nozzle 20 and for that reason may reduce any gap between the heater strip 30 and the standpipe 22 and nozzle 20 and the corresponding thermal resistance caused by that gap.

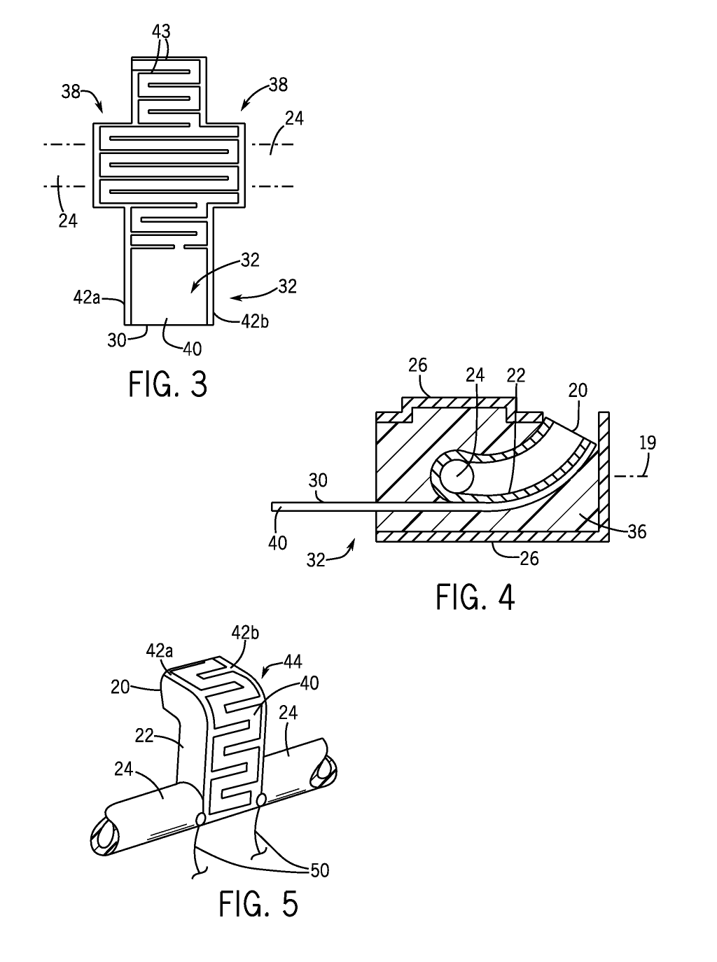

Referring to FIG. 3, in this regard, the heater strip 30 may be a simple rectangular flexible strip of sufficient length to extend into the housing 26 along the length of the standpipe 22 and be closely proximate to the standpipe 22. In addition, the heater strip 30 may include side wings 38 positioned to extend laterally slightly along the feeder tube 24 within the housing 26 to preheat liquid therein. In this regard, the side wings 38, being flexible, may be curved slightly to fit into the housing 26 and then to expand along the feeder tube 24 and even to curve slightly about the feeder tube 24 encouraged by the housing structure or the like to more closely conform to the feeder tube 24. Ideally the side wings 38 are in close contact with the feeder tube 24 over the majority of its length within the housing

Generally, the heater strip 30 may include a sheet polymer material 40 providing a flexible substrate on which is applied interdigitated electrodes 42a and 42b receiving the voltage source 34 as shown in FIG. 2. The polymer material 40 may provide for a high resistance conductance (greater than that of the electrodes 42) to provide a resistive heater element with a positive temperature coefficient to provide for self-regulating temperature control. As is understood in the art, positive temperature coefficient materials dramatically increase their resistance with increased temperature thus providing improved temperature regulation by decreasing current flow (and hence heating) as their temperature rises.

The interdigitated electrodes 42a and 42b are each connected to a different voltage polarity to apply a voltage across the polymer material 40 (for example, 12 volts DC) promoting current flow through the polymer material 40 generally along the plane of its extent suitable for heating in this application. Electrodes 42 may be, for example, screenprinted using conductive metallic inks or vapor-deposited, for example, of silver, aluminum or the like or applied as a thin decal or etched from an adhered film using integrated circuit techniques or a variety of other manufacturing processes.

Positive temperature coefficient (PTC) heaters, suitable for the flexible heater strip 30 of the present invention, are also disclosed in U.S. Pat. Nos. 4,857,711 and 4,931,627 to Leslie M. Watts hereby incorporated in their entirety by reference.

In one embodiment, the flexible heater strip 30 may be constructed of a flexible insulating sheet of insulating polymer material with a resistive positive temperature coefficient conductor applied to the upper surface to form a resistive or ohmic heating element. Alternatively, conventional resistive material may be used for the polymer material 40 or applied to the polymer material 40 and a constant current may be applied by the electrodes 42 across this material in “open loop” fashion or is controlled by a separate thermal sensor such as thermistor, thermostat or the like.

Referring now to FIG. 5, in an alternative embodiment, the nozzle 20, standpipe 22 and feeder tube 24 may be an integrated structure, for example, a single injection molded part providing an outer surface 44. The flexible heater strip 30 may then be insertion molded as part of this molded component. Alternatively, the outer surface 44 may be coated with a positive temperature coefficient resistive material or standard resistive material and electrodes 42 applied to that coating which may then attach to conductive leads 50, the latter of which may connect to the voltage source 34. The interdigitated structure of the resistive material may be formed by a printing process or by a laser or other etching of a thin film of resistive material uniformly applied and then removed to produce the interdigitated fingers. Alternatively, the body of the nozzle 20, standpipe 22, and feeder tube 24 may be comprised of a PTC polymer material either in its entirety or in a two-step molding process in which the PTC material is applied over a non PTC polymer core and electrodes applied across the PTC material.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context. When an element is indicated to extend along an axis this is intended to indicate the general orientation of the element for clarity and does not limit the element to a straight extension, only extension that has component along the axis.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

1. A vehicular washer nozzle assembly comprising:
a housing adapted to attach to a vehicle adjacent to a window;
a standpipe extending along an axis within the housing to terminate at a nozzle to direct a stream of liquid from the nozzle toward the window when the housing is attached to the vehicle; and
an elongate electrical heater element extending along a length of the standpipe to heat the standpipe, the elongate electrical heater element incorporating a resistive heating material.

2. The vehicular washer nozzle assembly of claim 1 wherein the elongate electrical heater is in contact with a majority of the length of the standpipe within the housing.

3. The vehicular washer nozzle assembly of claim 2 wherein the elongate electrical heater provides electrodes extending along substantially an entire length of the elongate electrical heater element within the housing adapted to communicate with a source of electrical power in the vehicle and separated by the resistive heating material.

4. The vehicular washer nozzle assembly of claim 3 wherein the electrodes each provide for a comb structure presenting interdigitated comb fingers.

5. The vehicular washer nozzle assembly of claim 4 wherein the resistive heating element is a polymer.

6. The vehicular washer nozzle assembly of claim 5 wherein the resistive heating element is a positive temperature coefficient heating element.

7. The vehicular washer nozzle assembly of claim 6 wherein the standpipe is curved and the elongate electrical heater curves to follow the standpipe.

8. The vehicular washer nozzle assembly of claim 7 wherein the resistive heating element is flexible to be curved during manufacture to follow the standpipe.

9. The vehicular washer nozzle assembly of claim 8 wherein the elongate electrical heater element is exposed outside the housing to expose the electrodes to connection.

10. The vehicular washer nozzle assembly of claim 9 further including a potting material for holding the elongate heater element in proximity with the standpipe.

11. The vehicular washer nozzle assembly of claim 6 wherein the standpipe joins with a feeder tube in a T-connection and the elongate electrical heater includes side arms that conform to the feeder to extending in opposite directions from the standpipe.

12. The vehicular washer nozzle assembly of claim 11 wherein the side arms are flexible to be curved for insertion into the housing and then to extend along the feeder tube.

13. The vehicular washer nozzle assembly of claim 11 wherein the elongate electrical heater is in contact with the majority of the length of the standpipe and feeder tube within the housing.

14. The vehicular washer nozzle assembly of claim 1 further including a potting material for holding the elongate heater element in proximity with the standpipe.

15. The vehicular washer nozzle assembly of claim 14 wherein the housing is constructed of a polymer material and the potting material has a lower thermal resistance than the housing.

16. The vehicular washer nozzle assembly of claim 1 wherein the housing and the standpipe are integrally formed as an injection molded component.

17. The vehicular washer nozzle assembly of claim 16 wherein the elongate electrical heater element is printed on an outer surface of the housing and standpipe as integrally formed.
